(19) United States
(12) Patent Application Publication
(10) Pub. No.: US 2011/0143613 A1
(43) Pub. Date: Jun. 16, 2011

(54) SHARK REPELLING ARRANGEMENT

(76) Inventor: Craig Stephen Wills, New South Wales (AU)

(21) Appl. No.: 12/737,061

(22) PCT Filed: Jun. 2, 2009
(86) PCT No.: PCT/AU2009/000694

§ 371 Date: Feb. 23, 2011

(30) Foreign Application Priority Data
Jun. 2, 2008 (AU) 2008902781

(51) Int. Cl. B63B 35/79; A01K 29/00; B65D 85/00

(52) U.S. Cl. 441/74; 119/712; 206/525

(57) ABSTRACT

A watercraft in the form of a body board comprising a planar body and a display unit adapted to display at least one animated image. The image is disposed at a bottom side of a lenticular lens. Each of the frames comprise an image of a head of a shark having a mouth opened at a predetermined width, thereby forming an animated image of the shark moving mouth so as to repel sharks. The display unit comprises a digital display, a controller and a power supply unit wherein the controller comprises memory for storing images and controls the images for displaying on the digital screen. The digital display comprises LCD. The supply unit comprises a solar power panel disposed on the top surface of the watercraft.

### TECHNICAL FIELD

The present invention relates to shark repellent marine products and shark repellent arrangement. In particular, the invention relates to a shark repelling arrangement for a water craft and marine equipment and apparel.

### BACKGROUND OF THE INVENTION

Every year there are numerous injuries and loss of human life caused by shark attacks. The users of small watercraft such as body boards, surfboards, sail boards, water skis, scuba diving equipment, life jackets, life rafts and small boats are especially vulnerable to such attacks. Accordingly, there has been a search for a system able to protect such users from shark attacks.

Some of the systems previously developed for protection from sharks include applying electrical pulses to an attacking animal. Possible disadvantages of such systems are the need to carry the associated equipment, which, depending on the design, can be large and heavy. In addition, in order to use such a defence system based on electrical pulse generation, the person should be aware of the impending shark attack which is often not the case.

Systems based on shark repellent substances that are manually released to prevent an attack have also been used. One such system is disclosed in U.S. Pat. No. 5,616,333, by Haas. According to this system, a shark repellent patch is provided which includes a highly flexible impermeable membrane sealing a shark repelling substance to a highly flexible base. Adhesive can be disposed on the other side of the base to allow attaching the shark patch to a selected surface. The membrane is provided with imperfections that allow a user to pull a tab connected to the membrane and to shear the membrane, upon an application of predetermined force. One disadvantage of such a system is associated with the fact that the highly flexible membrane is vulnerable to everyday use of the craft which it is attached to. Thus, the user has to remember to attach the patch before, as well as detach it after, each use of the watercraft. Another disadvantage relates to the fact that, again, the person using the craft has to be aware in advance of the shark attack so as to attempt to pull the tab and release the shark repellent liquid inside the membrane.

Accordingly, it would be advantageous if a system is designed that provides visual display to repel marine animal under the water.

### SUMMARY OF THE INVENTION

According to a first aspect the present invention provides a watercraft in the form of a surfing board comprising a substantially planar body; a display unit adapted to dispose on the body; wherein the display unit is adapted to display at least one animated image.

### BRIEF DESCRIPTION OF THE DRAWINGS

A preferred embodiment of the invention will now be described by way of example only and with reference to the accompanying drawings wherein:

FIG. 1 is a schematic plan view of the display arrangement for a watercraft, according to one embodiment of the invention.

FIG. 2 is an exploded section view of a portion of the watercraft of FIG. 1.

FIG. 3 is a section view of a portion of the watercraft of FIG. 1.

FIG. 4A is a side view of a portion of the watercraft according to another embodiment of the invention.

FIG. 4B is a side view of a portion of the watercraft according to yet another embodiment of the invention.

FIG. 5 is an image for displaying on the display of the watercraft of FIG. 1.

FIG. 6 is another image for displaying on the display of the watercraft of FIG. 1.

FIG. 7 is yet another image for displaying on the display of the watercraft of FIG. 1.

FIG. 8 is a schematic exploded view of components of a lenticular painting.

FIG. 9 is a schematic plan view of the repelling arrangement for a watercraft, according to one embodiment of the invention.

FIG. 10 is a schematic plan view of the shark repelling arrangement for a watercraft, according to a second embodiment of the invention.

FIG. 11 is a schematic plan view of a shark repelling arrangement for a watercraft, accordingly to a third embodiment of the invention.

FIG. 12 is a schematic plan view of a shark repelling arrangement for a watercraft, accordingly to a fourth embodiment of the invention.

FIG. 13 is a schematic plan view of a shark repelling arrangement for a watercraft, accordingly to a fifth embodiment of the invention.

### DESCRIPTION OF THE INVENTION

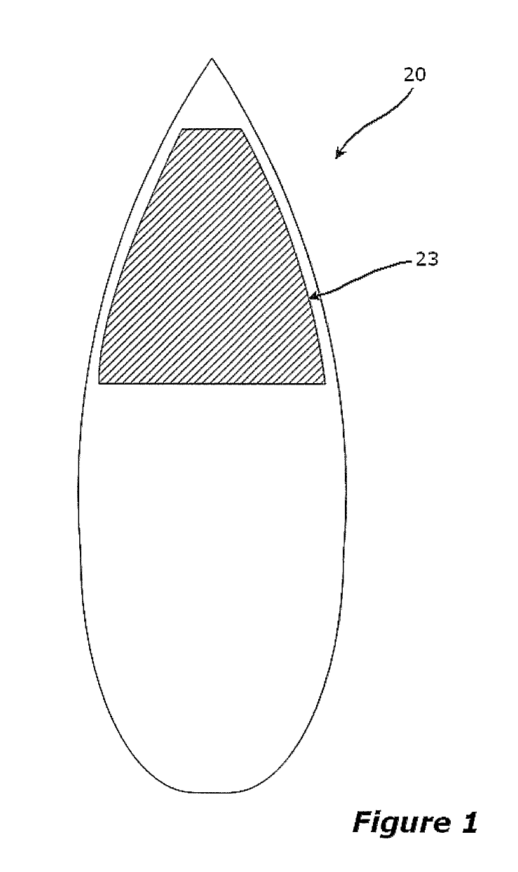

As illustrated in FIG. 1, one embodiment of the present invention provides a watercraft 20 which comprises a display 23 disposed on one side of the watercraft. In this case, the represented watercraft 20 is a surfboard, but it could also be a body board, windsurf board, water ski, scuba diving shield, life jacket, life raft or even a small boat, etc. The display 23 is either externally attached or imbedded within the body of watercraft 20. In the particular embodiment illustrated in FIGS. 1 to 4, the display 23 is disposed on the bottom side of the watercraft 20, so that it can display animated images or pictures for dispelling shark away.

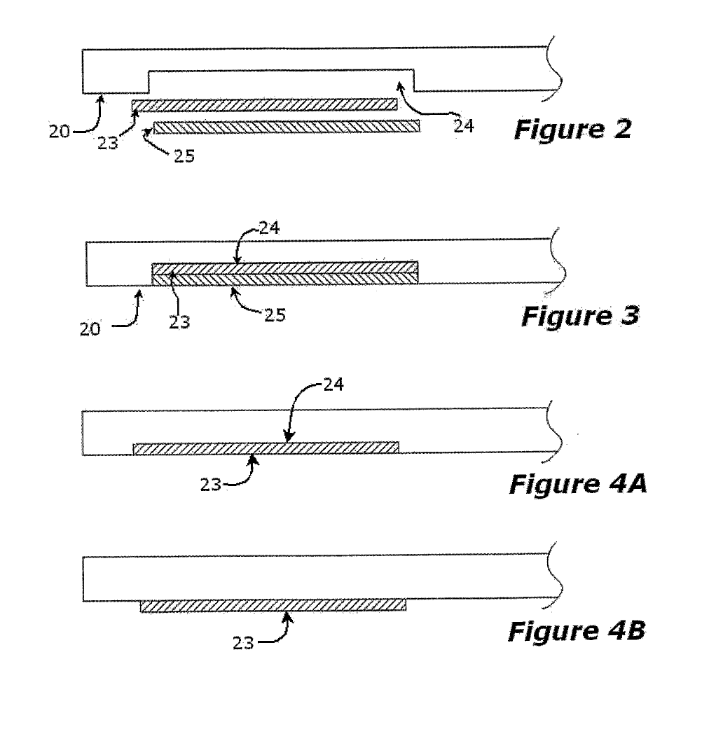

Referring to FIGS. 2 and 3, a recess 24 is provided at the bottom side of the watercraft 20 for fitting the display 23 within the recess. The display 23 is then securely attached to the recess 24 with adhesive or other attaching means such as screws or clips. Optionally, a protection layer 25 is provided for covering the display 23 inside the recess 24. Preferably, the watercraft 20 is further laminated with a very thin layer of non-opaque skin 26, such as fibre glass or wax to protect the watercraft and the display 23.

The display may extend along the entire surface of watercraft 20. An alternative configuration, where the display 23 is attached without the protection layer is shown in FIG. 4A. FIG. 4B illustrates another embodiment where the display 23 is externally attached to the watercraft 20.

It should be appreciated that the mechanical characteristics of the display 23 should be able to withstand the everyday wear and tear associated with the use of watercraft 20.

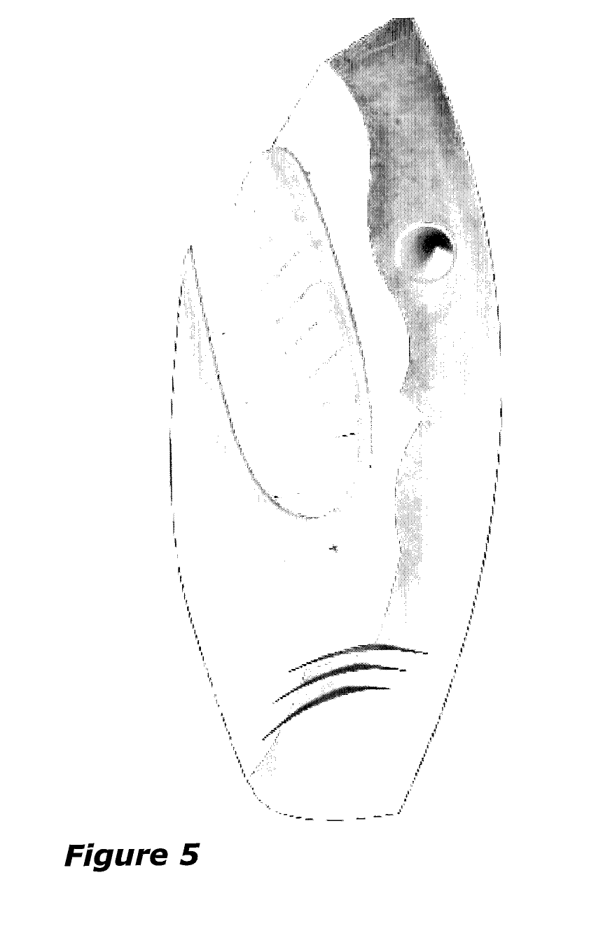

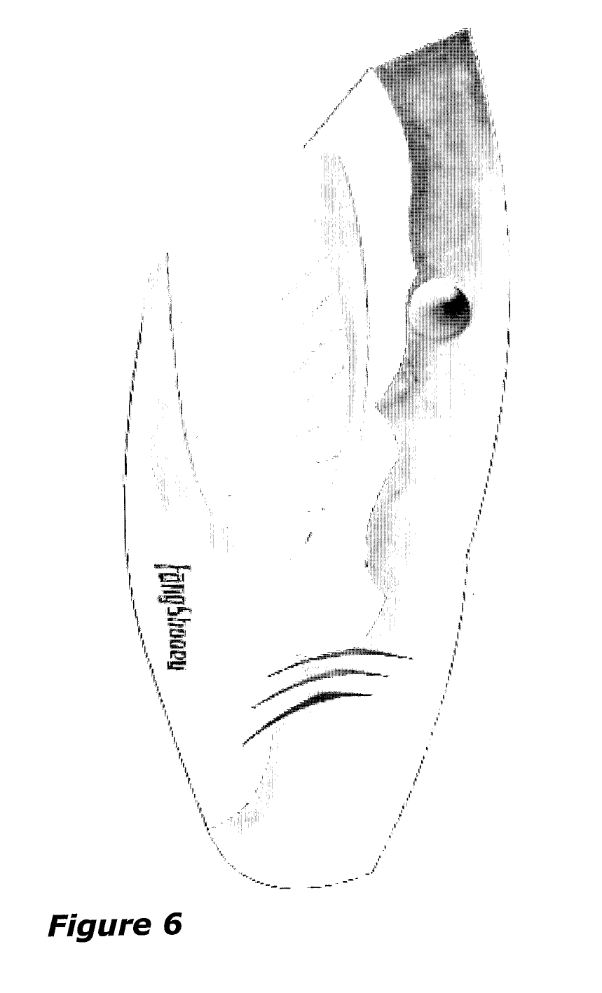

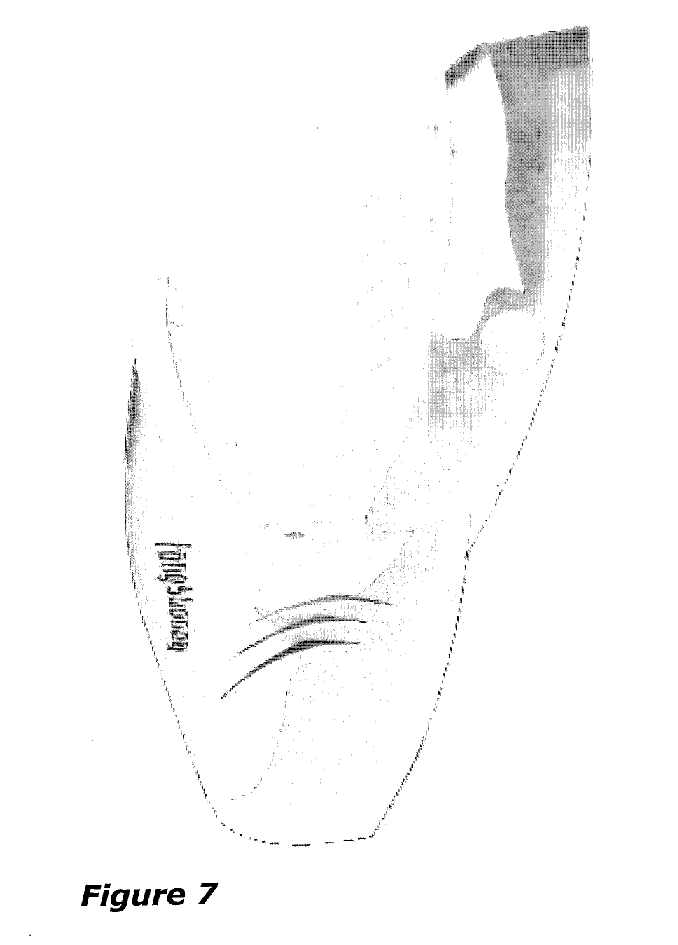

The display 23 is adapted to provide multiple functions, such as displaying advertisements, signs, signals, news, etc. In one preferred embodiment, the display 23 is adapted to display shark repelling images. FIGS. 5 to 7 show a set of shark repelling images. FIG. 5 shows a head of a shark with a slightly opened mouth. FIG. 6 shows the head of the shark of FIG. 5, wherein the mouth of the shark is opened wider than that of FIG. 5. FIG. 7 shows the head of the shark of FIG. 5, wherein the mouth of the shark is opened wider than that of FIG. 6. These images are displayed on the display 23 which produces an animated effect of a shark opening and closing its jaw for dispelling sharks away.

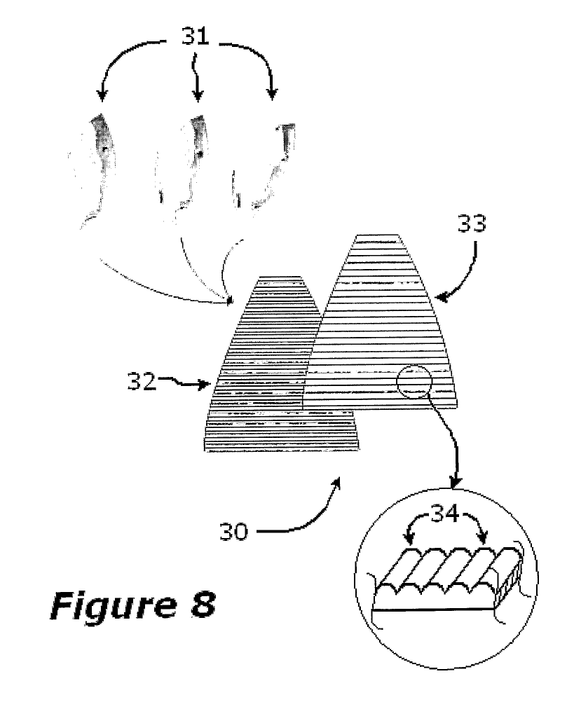

In one preferred embodiment, the display 23 is in the form of a lenticular painting 30 as shown in FIG. 8. The animated effect is produced by a lenticular painting 30 comprising a series of images 31, such as those shown in FIGS. 5 to 7, which are sliced into strips, and then interlaced with one or more other images to form a base image 32 for placing at a bottom side of a lenticular lens 33.

The interlacing process is preferably prepared with computer and suitable graphic manipulation software. However, interlacing process can also be accomplished by a manual means during or after the creation of the individual images. It is appreciated that durable ink such as solvent based inks are used to print the base image 32.

The lenticular lens 33 is preferably formed from a substantially transparent thermosetting polymer or plastic resins such as PVC, APET, PETG, Polycarbonate, Polypropylene, acrylic glass (PMMA), and Styrene. Preferably, the materials for making the lenticular lens are capable of withstanding UV radiation and a wide temperature range. Examples of such materials include acrylic and polycarbonate products.

The lenticular lens 33 has a non-planar surface defining a series of parallel lenticules 34 which are elongated parallel formations of narrow width and substantially uniform size and shape. These parallel lenticules 34 have a predetermined focal length correlated with the thickness of the polymer coating so as to focus substantially at the surface of the base image 32. The resulting base image 32 and polymer lenticular lens 33 form the composite lenticular painting 30 that provides a desired three-dimensional image, moving image, or multiple image visual effect. With the images 31 of FIGS. 5 to 7, the lenticular painting provides a shark head with an animated jaw for dispelling sharks away.

In another preferred embodiment, the display 23 is in the form of digital display which is controlled by a micro-controller connected to a power supply unit that provides power to the digital display and the micro-controller. The micro-controller comprises memory storage which is adapted to store images, for example the images of FIGS. 5 to 7. Examples of the digital display include LCD, OLED, TFT-LCD which are thin, light weight and cost effective. The digital display, the micro-controller and power supply unit are typically installed inside tight water seal which will provide extra protection and durability. The power supply unit comprises batteries or solar power panel. Preferably, the solar power panel is disposed on the upper surface of the watercraft 20.

It is appreciated that other type of images may be provided for displaying on the display 23 for other purposes, such as for advertisements and signs.

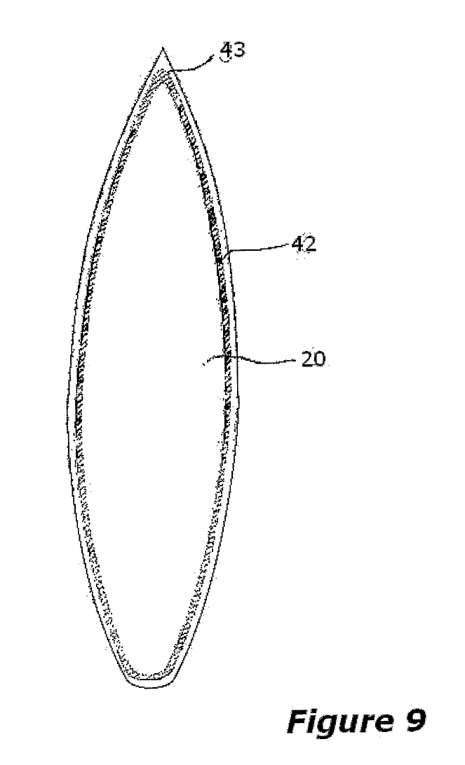

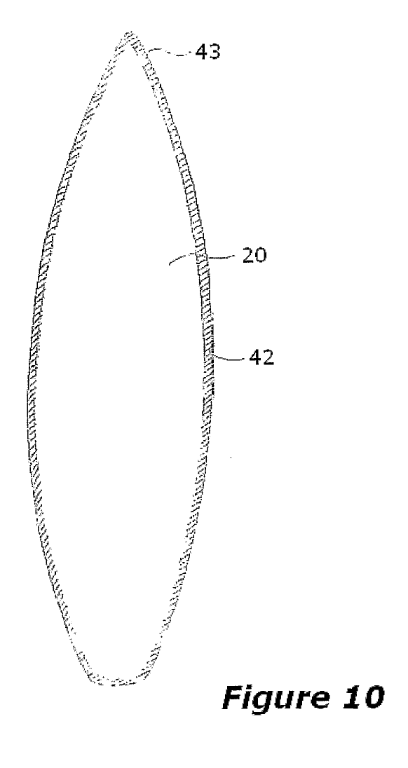

In another embodiment, as illustrated in FIG. 9, the shark repelling arrangement for a watercraft 20 comprises shark repellent 42 included in a continuous tube 43 located around the periphery of watercraft 20. Continuous tube 43 is either externally attached or imbedded within the body of watercraft 20. In the particular embodiment illustrated in FIGS. 9 and 10, tube 43 is located around the periphery of the board, so that a shark bite on any section of watercraft 20 would rupture tube 43 and release the contained shark repellent 42. It should be appreciated that the mechanical characteristics of the tube should be such that it would be able to withstand the everyday wear and tear associated with the use of watercraft 20, while, at the same time, it should also be arranged such that a shark bite would rupture the tube's walls and release the shark repellent. The rapture can be facilitated by introducing one or more lines of weakness along the length of the tube.

The tube may extend along the entire periphery of watercraft 20, or along a section of this periphery. An alternative configuration, where the tube is externally attached is shown in FIG. 10.

The containing means for the shark repellent may be a single continuous tube, or it may also be two or more containers. The containers may be in the form of smaller tubes, capsules, beads etc.

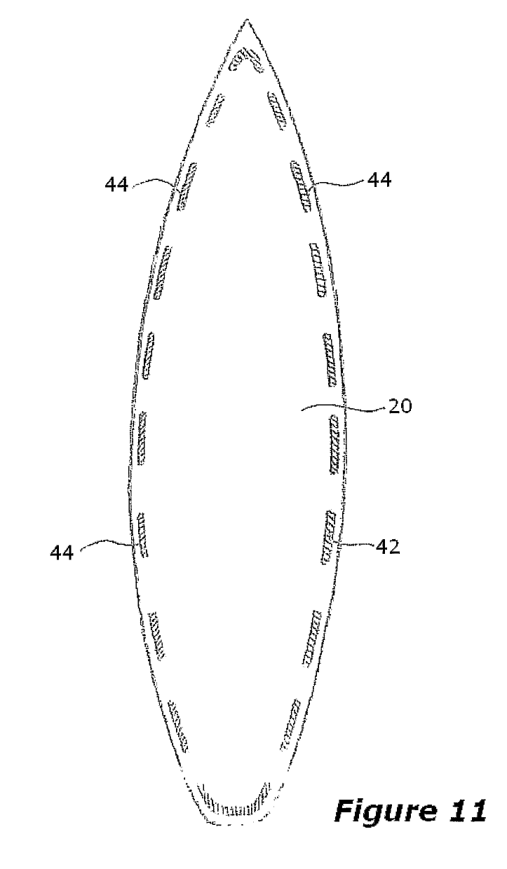

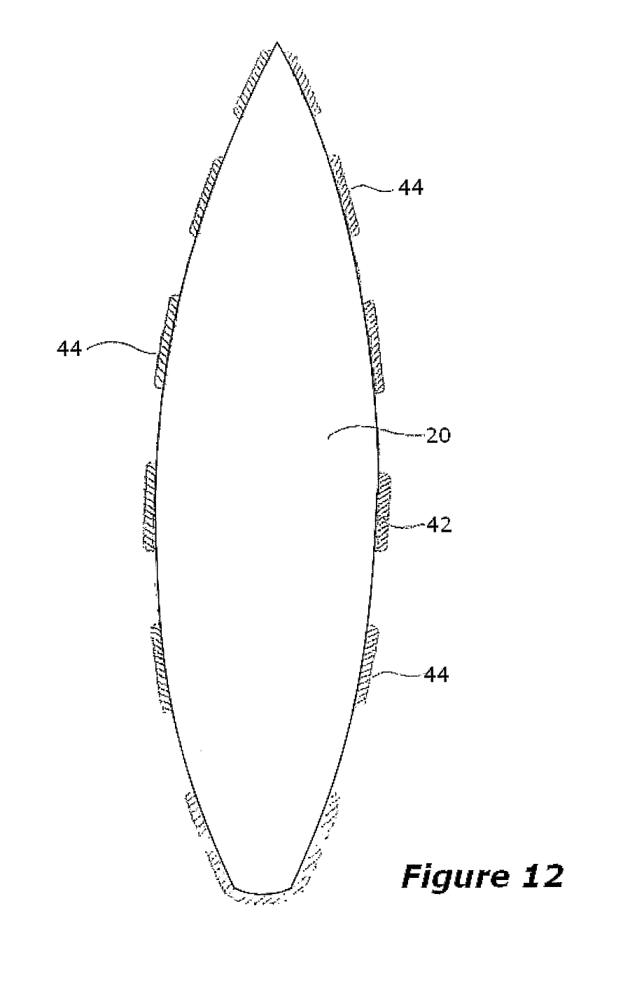

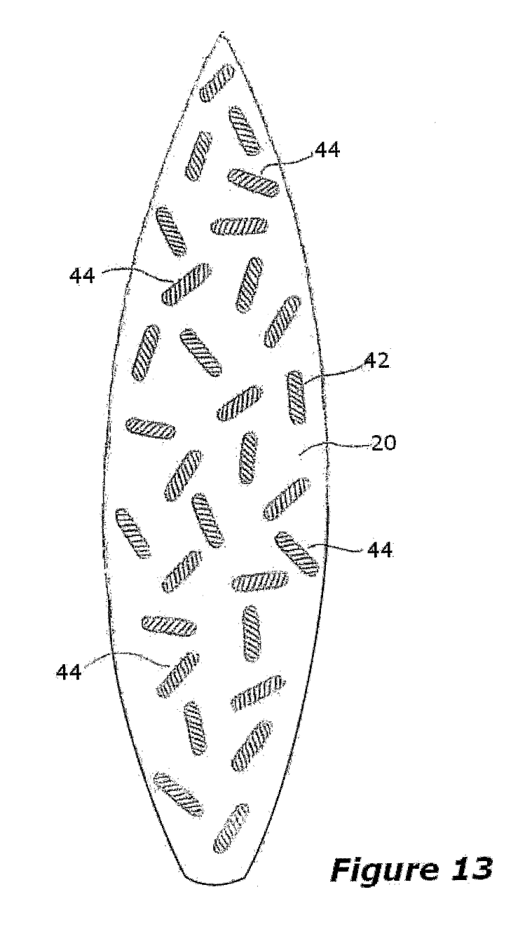

A configuration where the containing means including the shark repellent comprise a plurality of longitudinal container units 44, again disposed adjacent the periphery of the watercraft, is illustrated in FIG. 11 and FIG. 12. Containers 44 do not have to be located only around the periphery of the craft and could be spread, randomly or otherwise, across a section, or the entire area of the watercraft, as illustrated in FIG. 13. Of course a combination, where the containers are distributed along the periphery, as well as across at least a section of the area of the watercraft, can also be envisaged. Container units 44 can be disposed on, or be embedded within, the surface of watercraft 20. A combination where some units are external, and where others are internal, is also possible.

Although the containers represented in FIGS. 11 to 13 are of generally longitudinal shape, other shapes such as cubic, cylindrical, pyramidal etc are also possible. An advantage of having a plurality of small containers distributed around the periphery and/or across at least a section of the area of the surfboard is in the fact that a single bite or accidental damage of the surfboard destroys only some of the shark repellent containers, thus allowing re-use of the board. On the other hand, it would be obvious that a configuration including a single tube including the shark repellent has the advantage of releasing a substantial amount of repellent in the water in the case of a shark bite. The configuration used, the mechanical characteristics of the tubes and/or capsules, the distribution of the capsules across the area of the board and the particular way of attaching the tubes/capsules to the board is decided depending on the type of board, the force of the shark bite expected and the expected everyday wear and tear of the watercraft.

It will be appreciated that the disclosed shark repelling arrangement for a watercraft is relatively robust and is designed such that a shark bite automatically releases the contained shark repellent in the water, regardless of whether the user of the watercraft is aware or not of the shark attack. It should also be appreciated that the disclosed arrangement is not limited to the particular embodiment described in here, but also covers other arrangements using similar concepts. For example, any light watercrafts, using the above disclosed arrangements, also fall within the scope of this invention.

The expressions “comprising” and “including” in their grammatical variations, as used herein, are used in the inclusive sense of “having” and not in the inclusive of “consisting only of”.

1. A watercraft in the form of a body board, surfboard, windsurf board, or scuba diving shield board, the watercraft comprising:
a substantially planar body; and
a display unit adapted to dispose on the body;
wherein the display unit is adapted to display at least one animated image.

2. The watercraft according to claim 1, wherein the body has a recess at a bottom surface thereof, such that the recess is adapted to accommodate the display unit.

3. The watercraft according to claim 1, wherein the display unit comprises a base image disposed at a bottom side of a lenticular lens.

4. The watercraft according to claim 3, wherein the base image is formed by combining a series of frames, wherein the frames are divided into strips and interlaced with each other.

5. The watercraft according to claim 3, wherein the lenticular lens is made from a substantially transparent thermosetting polymer or plastic resins selected from the group consisting of PVC, APET, PETG, Polycarbonate, Polypropylene, acrylic glass (PMMA), and Styrene.

6. The watercraft according to claim 4, wherein each frame comprises an image of a head of a shark having a mouth opened at a predetermined width, thereby forming an animated image of the shark moving mouth.

7. The watercraft according to claim 2, wherein a protection layer is fitted to the recess for covering the display unit.

8. The watercraft according to claim 1, wherein the display unit comprises a digital display, a controller and a power supply unit, wherein the controller comprises memory for storage images, and controls the images for displaying on the digital display.

9. The watercraft according to claim 1, wherein the digital display comprises any one of OLED, TFT-LCD, and LCD.

10. The watercraft according to claim 9, wherein the power supply unit comprises a solar power panel, wherein the solar power panel is disposed on a top surface of the watercraft.

11. A shark repelling arrangement for a watercraft, the arrangement comprising:
shark repellent; and
at least one container for containing the shark repellent, each container being arranged for attaching to, or imbedding in, at least adjacent some of the watercraft's peripheral edges;
wherein the at least one container is arranged to withstand everyday wear and tear associated with use of the watercraft, and are also arranged such that a shark bite automatically releases the shark repellent inside a container

12. A shark repelling arrangement according to claim 11, wherein the at least one container comprises at least one solid container, the containing walls of the at least one solid container being configured to, in use, be ruptured by a shark bite so as to release the shark repellent.

13. A shark repelling arrangement according to claim 12, wherein the at least one container comprises a continuous tube arranged for disposal adjacent at least a section of at least some of the watercraft's periphery edges.

14. A shark repelling arrangement according to claim 12, wherein the at least one container comprises discrete containment units distributed adjacent at least some of the periphery edges of the watercraft.

15. A shark repelling arrangement according to claim 14, wherein the each container further comprises discrete containment units distributed across and/or embedded in at least a section of the watercraft's surface.

16. A shark repelling arrangement according to claim 14, wherein at least some of the containment units comprise capsules or beads.

17. A shark repellent containing means for containing shark repellent, the containing means being arranged for attaching to, or imbedding in, at least adjacent some of the peripheral edges of the watercraft;
wherein the containing means are arranged to withstand everyday wear and tear associated with the use of the watercraft, and are further arranged such that a shark bite automatically releases the shark repellent inside the containing means.

18. A shark repellent containing means according to claim 17, wherein the containing means comprise at least one solid container, the containing walls of the container being configured to, in use, be ruptured by a shark bite so as to release the shark repellent.

19. A shark repellent containing means according to claim 18, wherein the containing means comprise a continuous tube arranged for disposal adjacent at least a section of at least some of the periphery edges of the watercraft.

20. A shark repellent containing means according to claim 19, wherein the containing means comprise discrete containment units distributed adjacent at least some of the periphery edges of the watercraft.

21. A shark repellent containing means according to claim 20, wherein the containing means further comprise discrete containment units distributed across and/or embedded in at least a section of the surface of the watercraft.

22. A shark repellent containing means according to claim 20, wherein at least some of the containment units comprise capsules or beads.

23. A watercraft comprising the shark repelling arrangement of claim 11.

24. A shark repelling arrangement of claim 11, wherein the watercraft comprises one of a body board, surfboard, windsurf board, water-ski, scuba diving shield board, life jacket, life raft and a small boat.

25. A shark repelling arrangement of claim 12, wherein at least some of the walls of the containing means include at least one line weakness to facilitate the rapture.

26. A shark repellent containing means according to claim 17, wherein the watercraft comprises one of a body board, surfboard, windsurf board, water-ski, scuba diving shield board, life jacket, life raft and a small boat.

27. A shark repellent containing means according to claim 17, wherein at least some of the walls of the containing means include at least one line weakness to facilitate the rapture.

28. A watercraft according to claim 23, wherein the watercraft comprises one of body board, surfboard, windsurf board, water-ski, scuba diving shield board, life jacket, life raft and a small boat.
